(19) United States
(12) Patent Application Publication
(10) Pub. No.: US 2003/0158801 A1
(43) Pub. Date: Aug. 21, 2003

(54) Display particularly configured for visualizing trends in data

(76) Inventor: Mei Chuah, Palo Alto, CA (US)

Correspondence Address: ACCENTURE C/O MORRISON & FOERSTER, 755 PAGE MILL ROAD, PALO ALTO, CA, 94304, US

(21) Appl. No.: 10/072,421

(22) Filed: Feb. 5, 2002

(51) Int. Cl. G06F 17/60

(52) U.S. Cl. 705/36

(57) ABSTRACT

A method is provided to generate a display corresponding to a plurality of objects, on a display device. A plurality of portions of the display device are allocated to correspond to a plurality of separate domains into which the objects are categorized. With each portion, a shape is displayed for objects in the corresponding domain. The shapes are arranged in a spiral. The spatial relationship among the shapes in the spiral is determined based on a particular value of a characteristic associated with the objects. In accordance with a further aspect, a method is provided to generate a display, on a display device, representing at least one object. A plurality of portions of the display are allocated to correspond to a plurality of separate ranges of values of a first characteristic (such as time segments). At each of the plurality of portions, an indication is displayed of a value of a second characteristic of the at least one object in the range of the first characteristic to which that portion corresponds. In accordance with a further aspect, a method is provided to generate a display, on a display device, representing objects. A plurality of first shapes are generated on the display. Each first shape indicates a number of objects having a value of a first particular characteristic that is within a range of values corresponding to that first shape. Within each first shape, a second shape is generated for at least some of the objects associated with that first shape. Each second shape indicates a value of a second particular characteristic of that object.

### TECHNICAL FIELD

The present invention is in the field of visual metaphors for tracking trends in data sets and, in particular, relates to displays that, while presenting a view of a particular domain, also highlight particular trends in the data sets as an aid to decision making based on the data.

### BACKGROUND

Particularly during the internet boom, venture capital (VC) investments have yielded uncharacteristically high returns. As a result, start-up companies have found it relatively easy to attract VC investment. More recently, however, the volatile state of the capital markets has dictated that investors give investments greater scrutiny. That is, it has become important for each VC to monitor the state of the market and continually update its investment strategy to suit the rapidly changing market conditions.

A common problem faced by many venture capitalists is information overload. Venture capitalists are inundated with business plans from aspiring startups. Thus, it is desirable to filter out some of the business plans so that the remaining business plans are for startups that are most likely to yield significant returns on investment.

It is desirable to have tools to assist venture capitalists to make informed investment decisions and, in particular, to monitor investment flows and performance of startups and, other VC firms, over time. More generally, in other domains, it is desirable to have tools to assist in making informed decisions with respect to trends in data relating to those domains.

### SUMMARY

In accordance with one aspect of the invention, a method is provided to generate a display corresponding to a plurality of objects, on a display device. A plurality of portions of the display device are allocated to correspond to a plurality of separate domains into which the objects are categorized. With each portion, a shape is displayed for objects in the corresponding domain. The shapes are arranged in a spiral. The spatial relationship among the shapes in the spiral is determined based on a particular value of a characteristic associated with the objects.

In accordance with a further aspect of the invention, a method is provided to generate a display, on a display device, representing at least one object. A plurality of portions of the display are allocated to correspond to a plurality of separate ranges of values of a first characteristic (such as time segments). At each of the plurality of portions, an indication is displayed of a value of a second characteristic of the at least one object in the range of the first characteristic to which that portion corresponds.

In accordance with a further aspect of the invention, a method is provided to generate a display, on a display device, representing objects. A plurality of first shapes are generated on the display. Each first shape indicates a number of objects having a value of a first particular characteristic that is within a range of values corresponding to that first shape. Within each first shape, a second shape is generated for at least some of the objects associated with that first shape. Each second shape indicates a value of a second particular characteristic of that object.

### BRIEF DESCRIPTION OF THE DRAWINGS

FIG. 1 illustrates a hierarchical graphical display in which the lowest hierarchy is displayed in a spiral arrangement.

FIG. 1-1 illustrates a process to generate the FIG. 1 display.

FIG. 2 schematically illustrates the organization of a particular spiral arrangement in the FIG. 1 display.

FIG. 3 illustrates how a particular spiral arrangement of the FIG. 1 display changes over time.

FIG. 4 illustrates an alternate embodiment of the FIG. 1 display.

FIG. 5, which does not illustrate the invention, graphically illustrates a comparison of the performance of the top thirty largest VC firms in terms of total money invested.

FIG. 6 illustrates a compact representation of the performance of a single VC firm, including multiple timelines in a single representation.

FIG. 6-1 illustrates a process to generate the FIG. 6 display.

FIG. 7 illustrates a conglomeration of FIG. 6 display, for multiple VC firms.

FIG. 8 illustrates a variant of a conventional histogram display, in accordance with an embodiment of the invention, in which VC firms are associated with bars according to total investment and in which each bar includes an indication, for each VC firm associated with that bar, of the percentage of least successful startup companies within the portfolio of that VC firm.

FIG. 8-1 illustrates a process to generate the display of FIG. 8.

FIG. 9 illustrates a computer system on which the processes of FIGS. 1-1, 6-1 and 8-1 maybe implemented.

### DETAILED DESCRIPTION

In accordance with various aspects of the invention, three methods and systems for displaying trends in venture capital (VC) investment data are described. Thereafter, it is discussed how the described methods and systems have application to displaying trends in data other than VC investment data.

As discussed in the Background, one important task for venture capitalists is to monitor investment flows within the startup company's market. This gives VC firms a view of what competitor VC firms are doing, which industries are flourishing, which industries are reaching saturation, and whether there is any advantage to being first within a particular area (first mover advantage). Throughout this description, various example displays are shown. It should be noted that these example displays do not necessarily resemble displays that would be generated based on actual data.

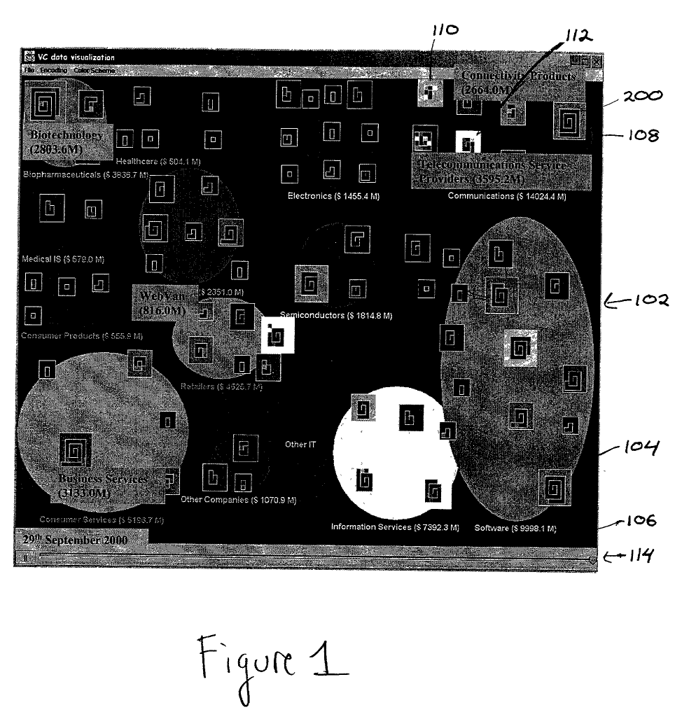

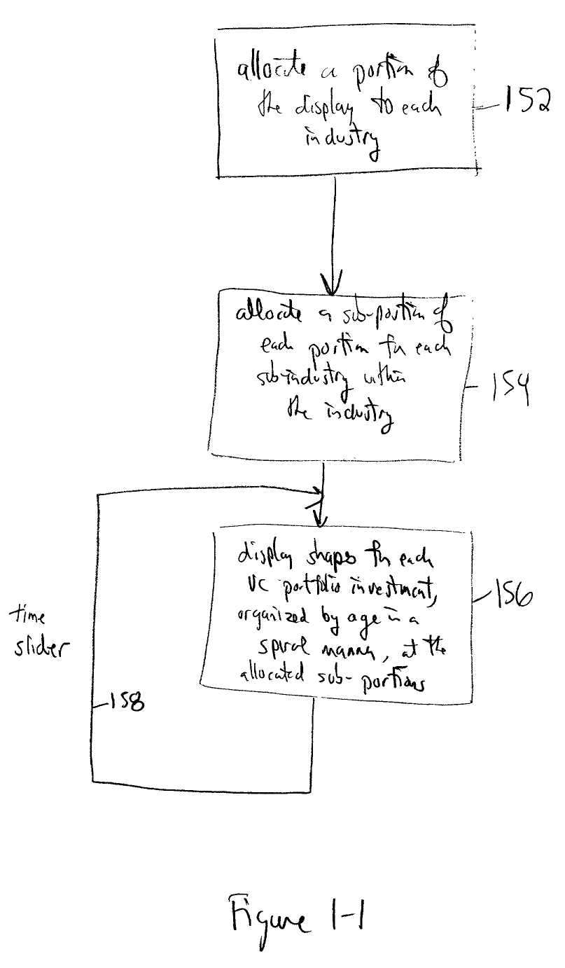

FIG. 1 illustrates a display (SpiralMap™ display) to assist the venture capitalist with this task. The display process (illustrated in FIG. 1-1) to generate the FIG. 1 display utilizes the three-level hierarchy of industry groups by which VentureOne (a VC information company headquartered in San Francisco, Calif.) categorizes VC portfolio companies. Turning now to FIGS. 1 and 1-1, at step 152 (FIG. 1-1), a portion of the display is allocated to each topmost level industry group. For example, in the FIG. 1-1 display, each such industry group is represented by an oval, an example of which is denominated by reference numeral 104 and is provided with an associated label 106 “Software ($9998.1 M)”. Each label 106 is indicative (for example, by color) of the industry group into which the corresponding industry can be categorized. For example, labels for industries in the information technology area (e.g., information services, software and communications) may be colored yellow, labels for industries in the healthcare area may be colored green, labels for industries in the retail area may be colored purple, and labels for other miscellaneous industries may be colored blue.

Furthermore, the color of each oval 104 indicates the total investment in the industry represented by the oval. (The figures of the patent application are black and white, and the shades roughly map to actual colors.) The size of each oval 104 roughly approximates the number of sub-industries and VC portfolio companies within the particular industry represented by that oval 104. The color of an oval 104 may be employed to encode any aggregate attribute of the industry represented by the oval, such as average investment per startup company or total investment for all startup companies in the industry.

Referring again to the FIG. 1-1 flowchart, at step 154, a square sub-portion of each oval is allocated to each sub-industry of the industry represented by the oval. The background color of each square sub-portion indicates the total investment within the sub-industry. For example, two relatively bright squares within the communications industry oval 108 are allocated to the connectivity products sub-industry 110 and to the telecommunications service providers sub-industry 112. The size of a particular square, on the other hand, is an indication of the number of startup companies within the sub-industry to which the square is allocated. Furthermore, the location of each square within an oval with respect to each other square within the oval is an indication of the “closeness” of the sub-industry represented by that square with respect to each other square.

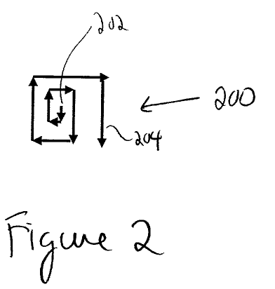

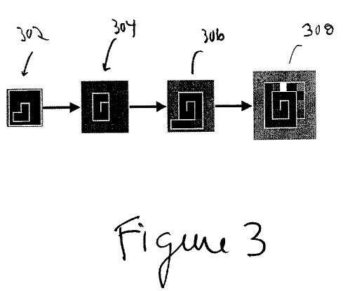

At step 156 of the FIG. 1-1 flowchart, shapes are displayed within the square allocated to a particular sub-industry for each startup company within that sub-industry. In particular, as illustrated with reference to FIGS. 2 and 3, multiple shapes (each referred to herein as a “company square”) are displayed within the sub-industry square, arranged in a spiral 200. The color of each company square indicates the total VC investment for the company represented by that square. For example, the brightest colors may indicate higher total investment while the darkest colors indicate lower total investment. The squares are arranged within the spiral 200 such that squares at the center of the spiral 200 represent the oldest companies (as determined by the date of the company's seed or first round investment), progressing to the outside 204 of the spiral where shapes representing the newest companies are located.

Referring specifically to FIG. 3, the squares 302, 304, 306 and 308 indicate a time progression of VC investment within a sub-industry. While the FIG. 3 display utilizes time, the display may be based on the progression of any characteristic. It can be seen from the color of the company squares in the spirals within the squares 302, 304, 306 and 308 that the younger companies (at the outside of the spiral) are generally more heavily financed (i.e., have larger VC investment) than the older companies (at the center of the spiral). This indication of time progression allows one to see whether companies that penetrated a particular sub-industry earlier (i.e., are located towards the center of the spiral) have an advantage over latecomers (located towards the outside of the spiral), or vice versa.

In accordance with other embodiments, each oval (representing an industry) and/or square (representing a sub-industry) is indicative of any aggregate attribute of the startup companies within that industry or sub-industry. For example, an oval or square may be displayed with a color that is indicative of an average investment for the startup companies within the industry or sub-industry, respectively.

Referring back to FIG. 1, in accordance with embodiments of the system, a time slider 114 is provided. As indicated by arrow 158 in FIG. 1-1, the time slider 114 may be operated to modify the time frame (e.g., from 1994 to 2000) of the data used to generate the display 100. In particular, when the time frame of the display 100 is modified, step 156 is performed to process the data of the new time frame. By manipulating the time slider 114, a user can see how the investment flows are changing through time (i.e., which industries are becoming “hot” and which are becoming “cold”), and how different industries and sub-industries are growing. For example, fast and rapid growth combined with relative low initial investments is an indicator of low barrier to entry, while a slowdown in growth in an indicator that an industry is reaching its saturation point. Referring again to FIG. 3, it can be seen that for the illustrated sub-industry, younger companies (the squares at the tail of the spiral) actually ended up being more heavily financed than the older companies, as indicated by the relative colors of the squares.

Thus far, the description with respect to the company squares has been such that each square representing a particular startup company is indicated with a color based on the total investment amount for that company. In accordance with some embodiments, each company square is displayed with a color that indicates an amount of total investment in the company represented by the square relative to other companies in the same sub-industry. For example, in accordance with one such embodiment, the square for the startup company with the highest total investment out of all startup companies in the sub-industry is displayed with a color that indicates “maximum”, and the square for the startup company with the lowest total investment is displayed with a color that indicates “minimum”. In accordance with another such embodiment, each company square is displayed with a color that indicates the total amount of investment in that company relative to other companies in the entire industry to which the company represented by the company square belongs, or even relative to all companies in all industries.

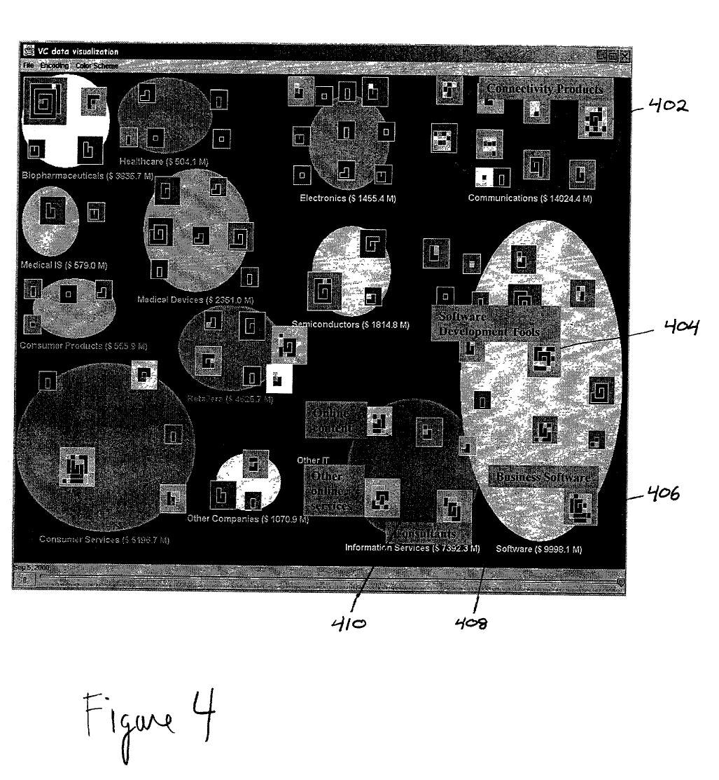

FIG. 4 illustrates a variation on the FIG. 1 display. In accordance with the FIG. 4 embodiment, each sub-industry square and company square is displayed with a color that facilitates the process of mining for white space. White space is a term used by VC's for industries or sub-industries that are successful (by some measure), but in which relatively few investments have been made. In other words, these are industries or sub-industries that were unanticipated by the investment community at large to be successful. In theory, at least, these areas yield the highest return on investment because they are highly profitable, and yet the profits are distributed among a smaller number of investors.

FIG. 4 illustrates a display visualization of the same data upon which the FIG. 1 display is based. In FIG. 4, each sub-industry square is displayed with a background color indicating the average investment among companies in that sub-industry. Furthermore, each company square is displayed with a color representing the market capitalization of that company at initial public offering, relative to all other companies regardless of sub-industry. For example, in the FIG. 4 embodiment, company squares displayed brightest are within the top 20% of all startup companies in terms of market capitalization at initial public offering. Market capitalization is utilized as a simple indication of company success. Thus, the sub-industry squares with a lot of bright company squares are the sub-industries with many successful companies. White space, therefore, indicates each sub-industry with relatively low average investment as indicated by the background color of the square representing that sub-industry with a lot of bright company squares. Some examples of such white space in FIG. 4 include the connectivity products 402, software development tools 404, business software 406, consultants 408, and online content 410 sub-industries. Other sub-industries may have high startup company success rates (many bright company squares), but also have relatively high average investment numbers. As a result, it can be inferred that such sub-industries are less profitable.

The displays described above with respect to FIGS. 1, 1-1, 2, 3 and 4 display financial data in a hierarchical manner. The SmartMoney map (see http://www.smartmoney.com/marketmap), derived from TreeMaps (see, for example, Shneiderman, Tree visualization with tree-maps: 2-d space-filling approach, ACM Transactions on Graphics, 11(1):92-99, 1992 also displays financial data in a hierarchical manner. However, in contrast to the SmartMoney map the display in accordance with some embodiments facilitates evaluation of VC investments. For example, the display in accordance with some embodiments provides an indication of first mover advantage. Furthermore, the position of an indication relating to a particular company may be fixed over time in the display, which allows easier determination from the display of trends through time—on a company, sub-industry and industry level. In the SmartMoney map, each company is tied to a square and the square sizes and positions are tied to encoded data. Thus the size and position of the squares change from one time slice to another based on changes in the encoded data.

In accordance with some embodiments of the display such as those shown in FIGS. 1 and 4, aggregate figures at a sub-industry and industry level are indicated. That is, the display indicates detailed information about each company simultaneously with aggregated figures for the sub-industry and industry to which the company belongs. The SmartMoney map only provides information about individual companies. While aggregate results may be visually approximated from the gestalt view of the individual companies, these aggregate results are not indicated explicitly.

In accordance with embodiments of the invention, the size of a sub-industry square indicates the number of startup companies in that sub-industry. This shows a level of saturation of the sub-industry, as well as indicating the rate of growth (when used together with the time slider 114). By contrast, the SmartMoney map does not provide an indication of saturation level, it is difficult to see how crowded an industry is because each company square has a different size.

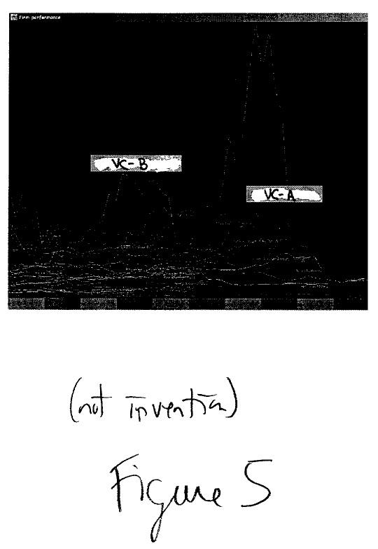

Now, a “TimeTicker™” display embodiment is discussed as a tool for examining VC investments. The display is discussed with reference to FIG. 5 (which are not illustrative of the invention but, rather, help to explain the invention) and FIGS. 6, 6-1 and 7. In addition to monitoring the investment flows with respect to startup companies and industries, it is also desirable to examine the performance of particular VC firms. For example, this can help enable one to identify broader investment strategies that are effective on a group or portfolio level. As another example application, this display embodiment can be used to track characteristics of individual stocks.

Timelines can be used to track the performance of various VC firms over time. For example, FIG. 5 illustrates a comparison of the performance of thirty large VC firms (in terms of total money invested). One problem with using timelines in the manner of FIG. 5 is that there is too much occlusion, which makes it difficult to compare among the performance of the different VC firms. All the information that can be derived from FIG. 5 is that the VC-A does very well towards the end of the time period while VC-B performs well during the middle period. Timelines are useful when comparing a small number of objects, but overcrowding makes it difficult to interpret timelines that include more than about ten objects.

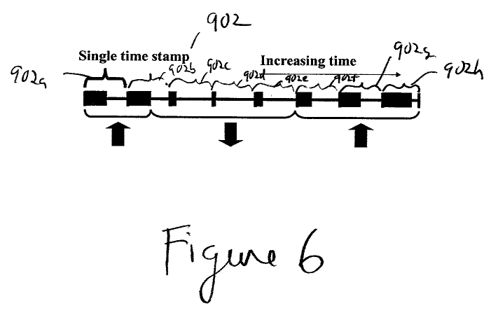

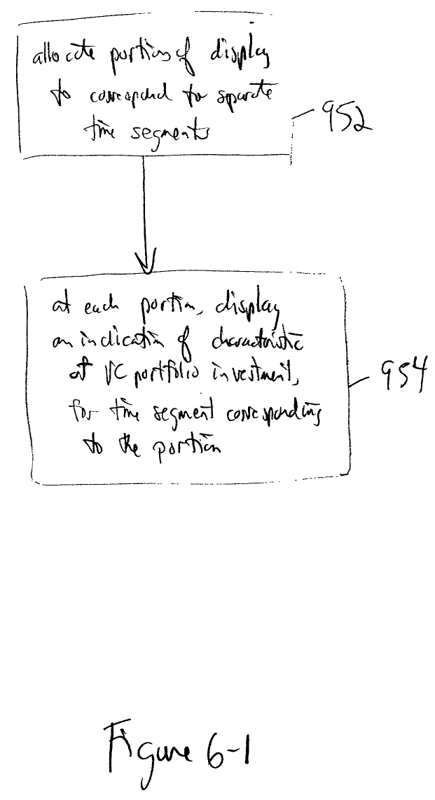

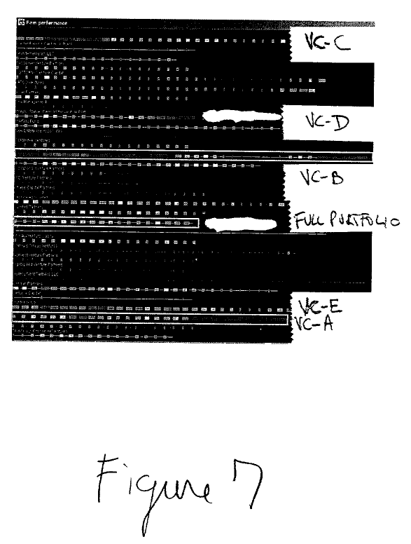

Now, the TimeTicker™ representation embodiment is described with reference to FIGS. 6, 6-1 and 7. FIG. 6 shows a graphical representation of investment results, over time for a single VC firm. As can be seen from FIGS. 6 and 7, this representation is compact and allows for comparison of results for many VC firms simultaneously. In FIG. 7, a separate line is displayed for each VC firm. Each line is divided into multiple segments 902 (902a through 902g in the specific display of FIG. 6), each segment corresponding to a separate time period. The display for each segment 902 includes a rectangle whose length corresponds to the performance of the VC firm for that particular time segment 902. For example, for the VC firm represented in FIG. 6, the VC firm performed well in the time periods represented by segments 902a and 902b. Then, the performance dropped (segments 902c and 902d). In the time period, corresponding to segments 902e through 902h towards the end of the time period represented by the FIG. 6 display, the performance of the VC firm improved. In addition to using the length of the rectangle to represent performance, the performance information may be encoded in the color or shade of the rectangle, as shown in FIG. 7.

FIG. 6-1 is a flowchart representing a process to generate the FIG. 6 display. At step 952, portions of the display are allocated to correspond to separate time segments. At step 954, at each allocated portion, an indication is displayed of a characteristic of a particular VC firm for the time segment corresponding to that allocated portion. For example, the characteristic may be return on investment as described above with reference to FIGS. 5.

FIG. 7 illustrates a display similar to the FIG. 6 display, but in which data representing multiple VC firms are displayed. Specifically, FIG. 7 displays data of the thirty VC firms for which data is shown in FIG. 5. Using the FIG. 7 representation, the performance of each VC firm can be more easily evaluated than with the FIG. 5 representation. For example, by the length of the rectangles on the lines for these VC firms, it can still be clearly seen that VC-A performs well towards the end time period and VC-B performs well during the middle time periods. In addition, it can also be seen that VC-C performed well in the initial time periods, VC-D performed well in the middle time periods, and VC-E has consistent performance throughout the time periods.

Now, with reference to FIGS. 8, 8-1 and 9 a Double Histogram™ (or histogram²™)embodiment in accordance with the invention is described. This display is useful for examining the correspondence between the size (or other first characteristic of a VC firm) and the success of its investments (or other second characteristic of the VC firm).

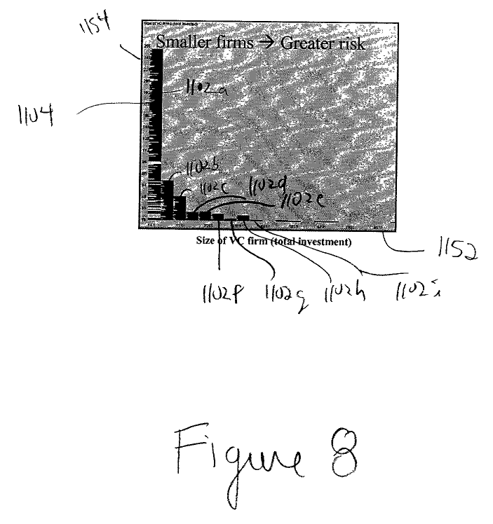

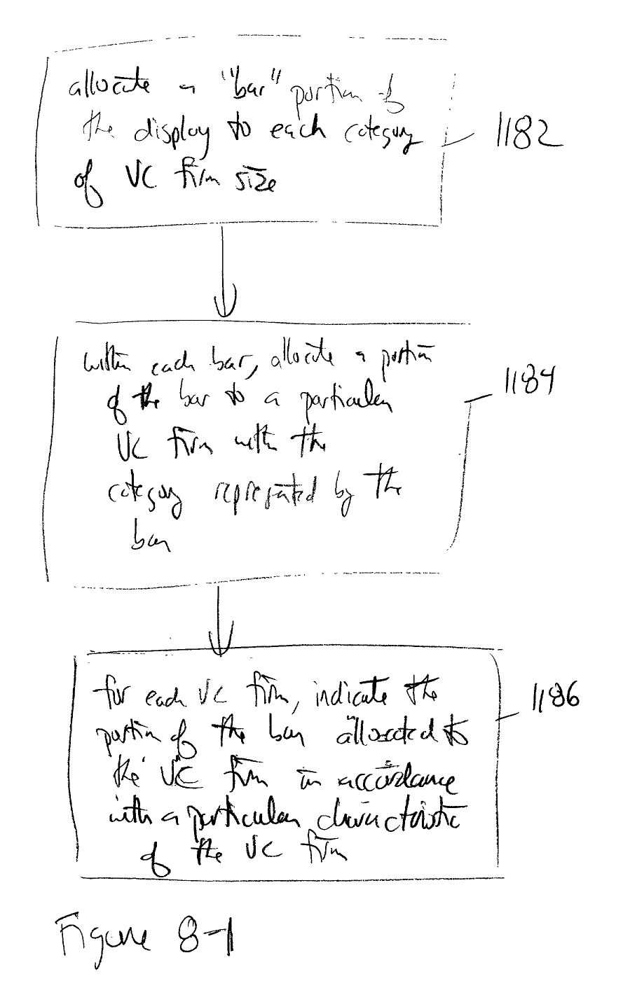

Referring to FIG. 8, a variant of a conventional histogram display is illustrated. The x-axis 1152 represents size of a VC firm as measured by the VC firm's total investment in startup companies. The height of each bar 1102a through 1102i (generically, 1102) indicates the number of VC firms in the sample for which the total investment of each such firm falls into a given range. So far, this is similar to a conventional histogram. However, each bar 1102 also includes a sub-histogram. Specifically, each rectangle 1104 (which in FIG. 8 is a rectangle having negligible width—a line) within a particular bar represents one VC firm. The length of each rectangle 1104 indicates the percentage of non-successful (by some measure) of startup companies with the portfolio of that VC firm. This VC firm rectangle may be displayed with a color that indicates the percentage of startup companies that fall into a particular range of success. For example, FIG. 8 is based on data for startup companies with low market capitalization on their IPO date (i.e. the less successful startups). The secondary rectangles (each corresponding to a separate VC firm) are then colored based on the number of startups within the portfolio of that VC firm that are also in the selected set. From FIG. 8, where brighter rectangles indicate a larger number of startup companies within the selected set, it can be seen that the least successful startups form the largest part of the small VC firms' portfolios. That is, there are many bright rectangles in the bar designated by reference numeral 1102.

It can be seen, then, that the type of display illustrated in FIG. 8 can be especially useful for finding relationships between the characteristics of objects (e.g., startup companies) and an associated container object (e.g., a VC firm that has invested in the startup companies). Thus, using the type of display illustrated in FIG. 8, the relationship between the total investment of VC firms and the market capitalization of the startup companies in which they invest can be seen. This is an advancement over the conventional scatter plot, because the scatter plot has high potential to occlude the data. This is particularly so when there are many data points that evidence a particular relationship, since these data points tend to be displayed in close proximity to each other on the scatter plot.

FIG. 8-1 is a flowchart illustrating a process to generate the displays of FIG. 8. At step 1182, a “bar” portion of the display is allocated to each category of VC firm size. At step 1184, within each bar portion, a portion of the bar is allocated to a particular VC firm within the category represented by the bar. At step 1186, for each VC firm, the display indicates a particular characteristic of the VC firm at the portion of the bar allocated to the VC firm.

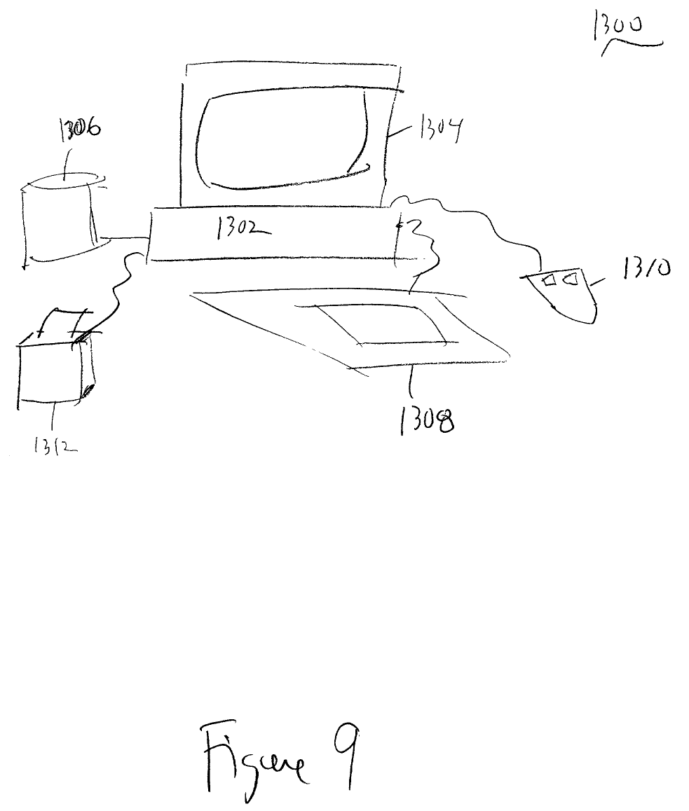

FIG. 9 illustrates one example of a computer system 1300 on which the present invention may be implemented. The box labeled 102 includes a CPU and other processing electronics. The CPU executes a program to process data in order to generate a display on display device 1304. The data may be held, for example, on storage device 1306. User input is provided via a keyboard 1308 and mouse 1310. A printer 1312 is provided, and may be used as a medium for generating the display.

Thus, in accordance with the various invention, VC investment data is more easily analyzed and useful information realized. The claims appended hereto are not intended to be limited to the specific embodiments disclosed herein. For example, the methods described also have applicability to domains of data other than VC investment data.

1. A method to generate a display, on a display device, representing venture capital investments in a plurality of industries, comprising:
allocating a plurality of portions of the display device to correspond to a plurality of separate industries;
allocating a sub-portion of each portion to a sub-industry of the industry to which that portion corresponds; and
within the sub-portion, displaying a shape for each VC portfolio company in that sub-industry, wherein the shapes are arranged in a spiral, including determining the spatial relationship among the shapes in the spiral based on a particular characteristic associated with the VC portfolio companies.

2. The method of claim 1, wherein:
the step of allocating a sub-portion of each portion includes allocating a plurality of sub-portions, each sub-portion allocated to a separate sub-industry of the industry allocated to that portion.

3. The method of claim 2, wherein:
the step of allocating the plurality of sub-portions includes arranging the sub-portions according to a characteristic of the sub-industries to which the sub-portions are allocated.

4. The method of claim 1, wherein:
the particular characteristic is a first particular characteristic; and
the shape displaying step includes displaying each shape with an indication of a second particular characteristic.

5. The method of claim 4, wherein:
the first particular characteristic is an amount of time since the VC portfolio company was seeded; and
the second particular characteristic is total VC investment for that company as of a particular time.

6. The method of claim 5, further comprising:
changing the particular time; and
modifying the display to account for the second particular characteristic as of the changed particular time.

7. The method of claim 6, further comprising:
changing the particular time based on input from a user.

8. The method of claim 7, further comprising:
displaying a user interface element indicating the particular time; and
receiving the changed particular time from a user via the user interface element.

9. The method of claim 4, wherein the indication with which each shape is displayed in the shape displaying step includes color.

10. The method of claim 4, wherein:
the first particular characteristic is an amount of time since a particular event occurred with respect to the VC portfolio company; and
the second particular characteristic is as of a particular time.

11. A method to generate a display, on a display device, representing objects in a plurality of categories, comprising:
allocating a plurality of portions of the display device to correspond to a plurality of separate categories;
allocating a sub-portion of each portion to a sub-category of the category to which that portion corresponds; and
within the sub-portion, displaying a shape for each object in that sub-category, wherein the shapes are arranged in a spiral, including determining the spatial relationship among the shapes in the spiral based on a particular characteristic associated with the objects.

12. The method of claim 11, wherein:
the step of allocating a sub-portion of each portion includes allocating a plurality of sub-portions, each sub-portion allocated to a separate sub-category of the category to which that portion is allocated.

13. The method of claim 12, wherein:
the step of allocating the plurality of sub-portions includes arranging the sub-portions according to a characteristic of the sub-categories to which the sub-portions are allocated.

14. The method of claim 11, wherein:
the particular characteristic is a first particular characteristic; and
the shape displaying step includes displaying each shape with an indication of a second particular characteristic.

15. The method of claim 14, wherein:
the first particular characteristic is an amount of time since a particular event occurred with respect to the object; and
the second particular characteristic is as of a particular time.

16. The method of claim 15, further comprising:
changing the particular time; and
modifying the display to account for the second particular characteristic as of the changed particular time.

17. The method of claim 16, further comprising:
changing the particular time based on input from a user.

18. The method of claim 17, further comprising:
displaying a user interface element indicating the particular time; and
receiving the changed particular time from a user via the user interface element.

19. The method of claim 14, wherein the indication with which each shape is displayed in the shape displaying step includes color.

20. A method to generate a display, on a display device, representing at least one venture capital firm, comprising:
a) allocating a plurality of portions of the display to correspond to a plurality of separate time segments;
b) at each of the plurality of portions, displaying an indication of a value of a characteristic of the at least one VC firm for the time segment to which that portion corresponds.

21. The method of claim 20, wherein:
the characteristic includes a return on investment measurement for the VC firm.

22. The method of claim 20, wherein:
the step of displaying an indication of a value of a characteristic of the venture capital firm includes displaying a rectangle having a length based on the value of the characteristic.

23. The method of claim 22, wherein:
the characteristic includes return on investment.

24. The method of claim 22, wherein:
the characteristic is a first characteristic;
the method further comprises displaying the rectangle with a color based on a second characteristic of the venture capital firm.

25. The method of claim 20, wherein:
the step of displaying an indication of a value of a characteristic of the corresponding venture capital investments includes displaying a shape having a color based on the value of the characteristic.

26. The method of claim 20, wherein:
the plurality of portions are first portions, and the at least one venture capital investment firm is a first venture capital firm; and
the method further comprises
allocating a plurality of second portions of the display to correspond to the plurality of time segments; and
at each of the plurality of second portions, displaying an indication of a value of the first characteristic of at least one second venture capital firm in the time segment to which that second portion corresponds.

27. The method of claim 26, wherein the first portion corresponding to a particular one of the time segments is adjacent to the second portion corresponding to the particular one of the time segments.

28. A method to generate a display, on a display device, representing at least one object, comprising:
a) allocating a plurality of portions of the display to correspond to a plurality of separate ranges of a first characteristic;
b) at each of the plurality of portions, displaying an indication of a value of a second characteristic of the at least one object for the range, of the first characteristic, to which that portion corresponds.

29. The method of claim 28, wherein:
the first characteristic includes time.

30. The method of claim 28, wherein:
the step of displaying an indication of a value of the second characteristic of the object includes displaying a rectangle having a length based on the value of the second characteristic.

31. The method of claim 30, further comprising:
displaying the rectangle having a color based on the value of a third characteristic of the object.

32. The method of claim 27, wherein:
the step of displaying an indication of a value of the second characteristic of the corresponding object includes displaying a shape having a color based on the value of the second characteristic.

33. The method of claim 27, wherein:
the plurality of portions are first portions, and the at least one object is a first object; and
the method further comprises
allocating a plurality of second portions of the display to correspond to the plurality of separate ranges of the first characteristic; and
at each of the plurality of second portions, displaying an indication of a value of the second characteristic of at least one second object in the range of the first characteristic to which that second portion corresponds.

34. The method of claim 33, wherein the first portion corresponding to a particular one of the time segments is adjacent to the second portion corresponding to the particular one of the time segments.

35. A method to generate a display, on a display device, representing venture capital investments, comprising:
generating a plurality of first shapes on the display, wherein each first shape indicates a number of associated venture capital firms having a value of a first particular characteristic within a range of values that correspond to that first shape;
within each first shape, generating a second shape for at least some of the venture capital firms associated with that first shape, wherein each second shape indicates a value of a second particular characteristic of that venture capital firm.

36. The method of claim 35, wherein:
the first shapes are rectangles; and
the second shapes are rectangles.

37. The method of claim 35, wherein:
the first shapes are rectangles; and
each first shape indicates the number of associated venture capital firms by the length of that rectangle.

38. The method of claim 35, wherein:
the second shapes are rectangles; and
each second shape indicates the value of the second particular characteristic by the length of that rectangle.

39. The method of claim 36, wherein:
each first shape indicates the number of associated venture capital firms by the length of the rectangle that is that first shape;
each second shape indicates the value of the second particular characteristic by the length of the rectangle that is that second shape; and
the lengths of the rectangles that are the second shapes are perpendicular to the lengths of the rectangles that are the first shapes.

40. The method of claim 38, wherein:
the second shape indicates a third particular characteristic of that venture capital firm by the color of the second shape.

41. A method to generate a display, on a display device, representing objects, comprising:
generating a plurality of first shapes on the display, wherein each first shape indicates a number of associated objects having a value of a first particular characteristic within a range of values that correspond to that first shape;
within each first shape, generating a second shape for at least some of the objects associated with that first shape, wherein each second shape indicates a value of a second particular characteristic of that object.

42. The method of claim 41, wherein:
the first shapes are rectangles; and
the second shapes are rectangles.

43. The method of claim 41, wherein:
the first shapes are rectangles; and
each first shape indicates the number of associated objects by the length of that rectangle.

44. The method of claim 43, wherein:
the second shapes are rectangles; and
each second shape indicates the value of the second particular characteristic by the length of that rectangle.

45. The method of claim 41, wherein:
each first shape indicates the number of associated objects by the length of the rectangle that is that first shape;
each second shape indicates the value of the second particular characteristic by the length of the rectangle that is that second shape; and
the lengths of the rectangles that are the second shapes are perpendicular to the lengths of the rectangles that are the first shapes.

46. The method of claim 45, wherein:
the second shape indicates a third particular characteristic of that object by the color of the second shape.
